(19) United States
(12) Patent Application Publication
(10) Pub. No.: US 2024/0211723 A1
(43) Pub. Date: Jun. 27, 2024

(54) ARTIFICIAL INTELLIGENCE DEVICE FOR PROVIDING RECOMMENDATIONS AND CONTROL METHOD THEREOF

(71) Applicant: LG ELECTRONICS INC., Seoul (KR)

(72) Inventors: Touqir SAJED, Toronoto (CA); Ali PESARANGHADER, Toronoto (CA)

(73) Assignee: LG ELECTRONICS INC., Seoul (KR)

(21) Appl. No.: 18/533,807

(22) Filed: Dec. 8, 2023

Related U.S. Application Data
(60) Provisional application No. 63/431,652, filed on Dec. 9, 2022.

(51) Int. Cl. G06N 3/04

(52) U.S. Cl. CPC G06N 3/04

(57) ABSTRACT

A method for controlling an artificial intelligence (AI) device can include, during an exploration stage, recommending each item within the group of items at least one time for outputting a first plurality of recommendations and receiving rewards for the first plurality of recommendations, storing a weighted average reward for each item in the memory, and storing a number of times each item within the group has been recommended. The method can further include, during an exploration-exploitation stage subsequent to the exploration stage, determining a maximum expected reward value for each item within the group of items based on the weighted average reward received for each item within the group of items, upper confidence bound value for each item within the group of items and a user preference value for each item within the group of items, and outputting a recommendation identifying an item having a highest maximum expected reward.

### CROSS-REFERENCE TO RELATED APPLICATIONS

This non-provisional application claims priority under 35 U.S.C. § 119(e) to U.S. Provisional Application No. 63/431,652, filed on Dec. 9, 2022, the entirety of which is hereby expressly incorporated by reference into the present application.

### BACKGROUND

### Field

The present disclosure relates to a device and method for an interactive recommender device, in the field of artificial intelligence (AI). Particularly, the method can provide a non-stationarity, upper confidence bound (NS-UCB) multi-armed bandit recommender that can receive user preferences and make a recommendation while taking into account context information and learning from feedback to provide better, more relevant recommendations, in the AI field.

### Discussion of the Related Art

Recommender systems have gained significant traction in recent years, driven by the growing need to automate the process of catering to user preferences. These systems have revolutionized the way people receive recommendations, facilitating the promotion of advertisements and products, including movies and various content, while maximizing user engagement.

Without the advent of recommender systems, navigating through vast amounts of data and manually providing personalized recommendations would have been an insurmountable task. Recommender systems often fall under the category of interactive recommenders, ranging from simple click-based advertisement recommenders to sophisticated conversational systems that not only suggest products but also engage in natural dialogues. While most recommendation systems operate in an offline mode, recent research has focused on developing online learning algorithms for recommender systems.

Recommendation systems face the challenge of identifying items or actions that consistently maximize user satisfaction, as preferences can change over time. For instance, a restaurant recommender system may initially recommend a restaurant that a user enjoys, but the user's satisfaction may decline as he or she tries all the dishes and becomes bored with that restaurant or the restaurant's quality begins to decline.

Similarly, a movie recommender system may initially recommend movies that a user finds enjoyable, such as movies directed to a specific genre (e.g., comedies), but the satisfaction may wane over time as the user may want to explore different genres, directors, or actors. This shift in preferences, known as non-stationarity, can pose a challenge for recommender systems.

Also, a user's preferences may change based on the surrounding context (e.g., geographic location, time of day, day of the week, and season, etc.). For example, a user my prefer scary movies during the month of October, but during December, the user may prefer to watch only holiday movies.

In addition, personalized recommender systems often use matrix factorization, which is usually based on singular value decomposition (SVD). These approaches typically learn a low-dimensional joint latent representation of items and users based on a ratings matrix and then recommend items that maximize a similarity function (e.g., dot product) between the latent representations of items and the particular user.

However, these personalized recommendation methods suffer from several limitations: (1) their performance deteriorates significantly as the sparsity of the ratings matrix increases, (2) their offline nature makes it challenging to incorporate new users, items, or even ratings, (3) their computational complexity limits their applicability to large-scale datasets, (4) while some extensions attempt to address the cold start problem, where recommendations must be made without prior data, most techniques struggle with this issue, and (5) they struggle with issues regarding non-stationarity.

Accordingly, there is a need for a recommender that can improve performance while better adapting to non-stationarity that is present in feedback or reward signals, and consistently recommend items that align with evolving preferences, which can also reduce computation time and conserve resources.

### SUMMARY OF THE DISCLOSURE

The present disclosure has been made in view of the above problems and it is an object of the present disclosure to provide a device and method that can provide better recommendations and dynamically align with evolving preferences or changing rewards.

It is another object of the present disclosure to provide a method and device that can include an exploration stage where: i) each item in the group is recommended at least once to gather feedback, ii) the average reward for each item is recorded, and iii) the number of times each item has been recommended is tracked and stored in memory; and an exploration-exploitation stage, subsequent to the exploration state, where: iv) a maximum expected reward value, an upper confidence bound value, and a user preference value are calculated for each item based on the gathered data, and v) the item having the highest sum of the maximum expected reward, the upper confidence bound value, and the user preference value is the item that is selected and recommended to the user.

An object of the present disclosure is to provide a method for controlling an artificial intelligence (AI) device that includes storing, in a memory of the AI device, item information, user preferences and reward feedback information; obtaining, via a processor in the AI device, item information for a group of items; receiving, via the processor, at least one user preference; during an exploration stage, recommending each item within the group of items at least one time for outputting a first plurality of recommendations and receiving rewards for the first plurality of recommendations, storing a weighted average reward for each item within the group of items in the memory, and storing a number of times each item within the group has been recommended in the memory; and during an exploration-exploitation stage subsequent to the exploration stage, determining a maximum expected reward value for each item within the group of items based on the weighted average reward received for each item within the group of items, an upper confidence bound value for each item within the group of items and a user preference value for each item within the group of items, and outputting a recommendation identifying an item having a highest maximum expected reward among the group of items.

Another object of the present disclosure is to provide a method in which the maximum expected reward value for a specific item within the group of items is a sum of the weighted average reward received for the specific item, the upper confidence bound value for the specific item and the user preference value assigned to the specific item.

Another object of the present disclosure is to provide a method to compute the maximum expected reward as the sum of the weighted reward average and upper confidence bound value.

An object of the present disclosure is to provide a method in which the exploration stage is carried out K times to generate the first plurality of recommendations, K being equal a number of items within the group of items.

Another object of the present disclosure is to provide a method in which the user preference value is a rating received from a user that is normalized to be a value in a range of −1 to 0.

An object of the present disclosure is to provide a method that further includes updating a weighted sum for each item within the group of items, the weighted sum being based on a number of times a corresponding item has been recommended, in which the upper confidence bound value becomes larger as the weighted sum becomes smaller.

Another object of the present disclosure is to provide a method that further includes displaying, on a display of the AI device, the recommendation identifying the item having the highest maximum expected reward among the group of items.

Another object of the present disclosure is to provide a method in which the upper confidence bound value is based on an iterative logarithm function.

An object of the present disclosure is to provide a method that further includes receiving a chat message or a text message from the user including a rating or a score.

An object of the present disclosure is to provide an artificial intelligence (AI) device for providing recommendations, which includes a memory configured to store item information, user preferences and reward feedback information; and a controller configured to obtain item information for a group of items, receive at least one user preference, during an exploration stage, recommend each item within the group of items at least one time for outputting a first plurality of recommendations and receiving rewards for the first plurality of recommendations, store a weighted average reward for each item within the group of items in the memory, and store a number of times each item within the group has been recommended in the memory, and during an exploration-exploitation stage subsequent to the exploration stage, determine a maximum expected reward value for each item within the group of items based on the weighted average reward received for each item within the group of items, an upper confidence bound value for each item within the group of items and a user preference value for each item within the group of items, and output a recommendation identifying an item having a highest maximum expected reward among the group of items.

Another object of the present disclosure is to provide a method for controlling an artificial intelligence (AI) device that includes storing, in a memory of the AI device, item information, user preferences and reward feedback information; obtaining, via a processor in the AI device, item information for a group of items; receiving, via the processor, at least one user preference; in response to receiving a first recommendation request, recommending a first item within the group of items for outputting a first recommendation; receiving a first reward for first recommendation; storing an average reward for the first item in the memory, the average reward being based on the first reward; storing a number of times the first item has been recommended in the memory; and in response to receiving a second recommendation request, determining a maximum expected reward value for the first item based on the weighted average reward, an upper confidence bound value for the first item and a user preference value for the first item, and outputting a second recommendation based on a highest maximum expected reward for the first item.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example flow chart of a method for controlling an AI device according to an embodiment of the present invention.

FIG. 5 illustrates an example of a user interacting with an AI device according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

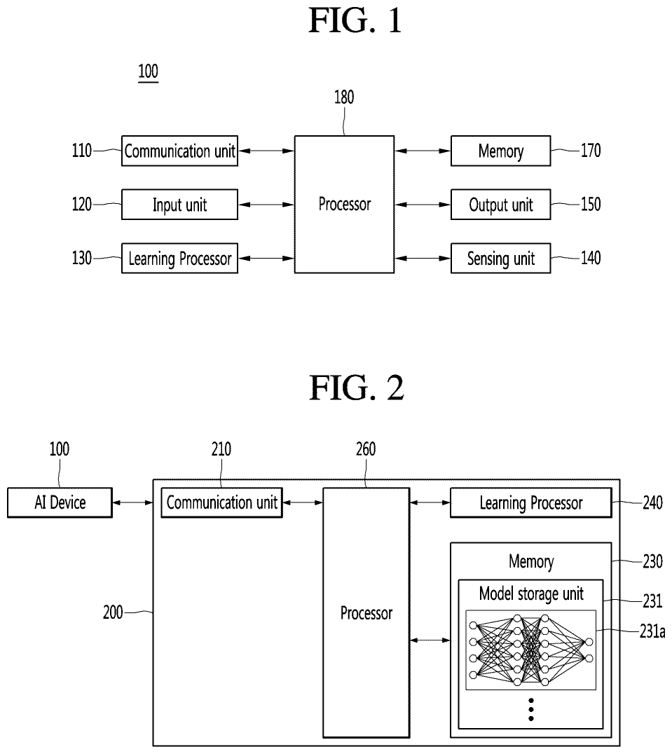

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

The communication unit 110 (e.g., communication interface or transceiver) can transmit and receive data to and from external devices such as other AI devices 100a to 100e and the AI server 200 by using wire/wireless communication technology. For example, the communication unit 110 can transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to an infer result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can execute a recommender or a recommendation system. The recommender can recommend an item to a user or an action to pursue from available options or actions.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including the operation contents of the AI apparatus 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server connected to a robot according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in memory 230.

The processor 260 can infer the result value for new input data by using the learning model and can generate a response or a control command based on the inferred result value.

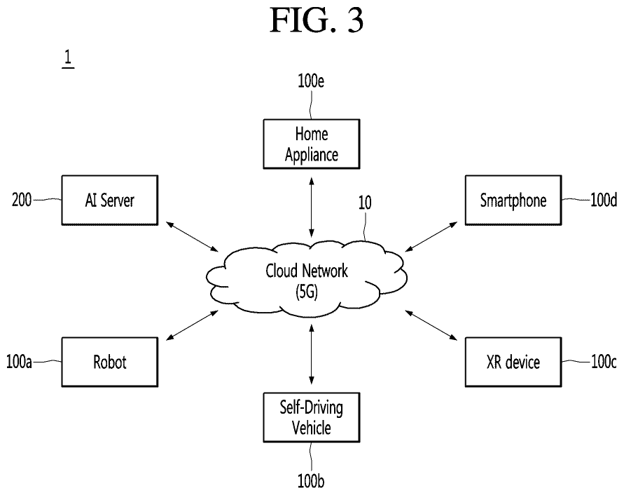

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the learning model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

The robot 100a, to which the AI technology is applied, can be implemented as an entertainment robot, a guide robot, a carrying robot, a cleaning robot, a wearable robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can implement a recommender to determine an action to pursue or an item to recommend.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

Also, according to an embodiment, the robot 100a can be a cleaning robot that can execute a recommender and choose from among a plurality of different routes or methods for cleaning a given space (e.g., a room), and upon completion of the job or cleaning, a user can provide feedback (e.g., please rate the job on a scale of 1 to 5, etc.). During a subsequent session, the robot 100a, executing the recommender, can recommend a route or method for the user to select or try out.

At this time, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

Also, according to an embodiment, the self-driving vehicle 100b that can execute a recommender and choose from among a plurality of different routes or commutes to arrive at a user destination, and upon arrival, a user can provide feedback (e.g., please rate the driving session or commute on a scale of 1 to 5, etc.). Also, user ratings can be normalized (e.g., to be 1 or 0, etc.). During a subsequent session, the self-driving vehicle 100b, configured with the recommender, can recommend a different route or commute to the user to try out.

According to an embodiment, the AI device 100 can be a recommender device that is configured to recommend an item, a route or an action to pursue. Further, the AI device 100 can be a recommender device that makes a recommendation based on a type of multi-arm bandit algorithm.

For example, a multi-arm bandit scenario can represent a situation in which a player or a gambler (e.g., can correspond to a recommender) is standing in front of a row of slot machines (e.g., colloquially referred to as a “one-armed bandit”), each slot machine presenting a chance to win big. The user has a limited amount of coins to spend on the slot machines, and needs to make wise decisions for selecting which slot machines to play, in order maximize his or her total winnings.

Also, in terms of a recommendation device, the arms of the slot machines can represent items or actions to recommend to a user, in which a good recommendation can receive positive feedback from the user (e.g., a positive rating or high rating) while a bad or undesirable recommendation can receive negative feedback from the user (e.g., a negative rating or low rating).

Further in this example, each time the user pulls the lever of a slot machine (or is presented with a recommendation), a reward is received (e.g., either the user wins money or gets nothing). Also, instead of a monetary reward, positive or negative user feedback can be received (e.g., a star rating, a click-through event or non-click through event, completion or non-completion of a purchase, amount of user engagement time, etc.). The goal is to find the slot machine that gives the highest weighted average reward and to pull its lever most often to maximize the overall winnings.

However, the challenge lies in the limited knowledge the player has about each slot machine's true payout rate (e.g., reward distribution). At the beginning, the user does not know which machine is the most generous, and the user needs to explore the various options before he or she can start exploiting the best one.

A multi-arm bandit algorithm can help address this type of scenario, which can balance exploration and exploitation by keeping track of the estimated rewards for each slot machine. In each round, the user can pull the lever of the machine with the highest estimated reward. For example, the player can keep track of a running weighted average reward for each slot machine (e.g., total rewards received from a specific slot machine divided by the number of times that specific slot machine has been played or arm pulls). Over time, as more information is gathered, the estimates become more accurate, and the user can focus on pulling the lever of the machine that consistently provides the highest rewards (e.g., convergence).

Also, any type of real world situation that can be modeled as a game, can likely be addressed with a multi-arm bandit algorithm. For example, an online advertising platform can use a multi-arm bandit algorithm to select which advertisement to display, a content streaming service can use a multi-arm bandit algorithm to select which movie or television show to recommend to a user, or a home appliance maker can use a multi-arm bandit algorithm to select a product to recommend to a buyer, etc.

In addition, a multi-arm bandit algorithm can be used instead of traditional A/B product testing, which can be especially helpful when there is a large number of options or items. For example, a multi-arm bandit algorithm can be used to determine which website layout, from among a plurality of different website layout designs, is the best or most effective.

However, this situation above assumes that the reward distribution for each slot machine or each item to recommend does not change over time. In many real world situations, the rewards are not static, rather they exhibit non-stationarity. For example, a user's preferences may change and evolve over time. For instance, a restaurant recommender system may initially recommend a restaurant that a user enjoys, but the user's satisfaction may decline as he or she tries all the dishes and becomes bored with that restaurant or the restaurant's quality begins to decline over time (e.g., in an effort to increase profit margins, the restaurant may start to use cheaper ingredients).

Also, the recommender device can be implemented in an online environment. In the dynamic environment of online item recommendation, a challenge arises from the trade-off between exploration and exploitation. The recommender should balance experimenting with new items to gather sufficient information about their quality or desirability and prioritizing items that have consistently received positive feedback from users.

According to an embodiment, a recommender device can randomly recommend all items during an exploration phase approach, followed by selecting the most favorably received item for exploitation in a subsequent exploitation phase, but embodiments are not limited thereto. However, this strategy may overlook the inherent noisiness of user feedback and the dynamic nature of user preferences. Also, it can become difficult to determine the optimal duration of the exploration phase to ensure future consistency.

Moreover, user perceptions of item quality or desirability can evolve over time, introducing an element of non-stationarity into the feedback dynamics (e.g., an item that is popular today may be passe tomorrow). This further complicates the decision-making process, as the recommender should adapt to changing user preferences while maintaining a balance between exploration and exploitation.

Thus, a challenge lies in navigating this trade-off effectively, considering the uncertainties introduced by noisy feedback and non-stationary preferences. A goal is to strike a balance that allows the recommender to gather sufficient information without sacrificing user satisfaction due to prolonged exploration.

According to an embodiment, a recommender can be based on a multi-arm bandit algorithm that includes an exploration stage and an exploitation stage. Also, the recommender device can further account for non-stationarity and incorporate user preferences.

Further, the recommender device can receive “soft” preferences from the user and “hard” preferences from the user. The soft preferences can be used to place a higher priority or weight for a given item to boost its chances of being recommended, and the hard preferences can be used to assign a lower priority or eliminate certain items from consideration altogether, but embodiments are not limited thereto.

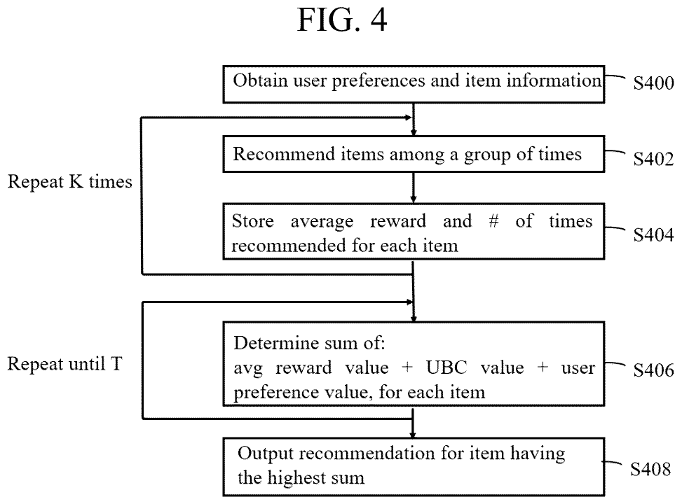

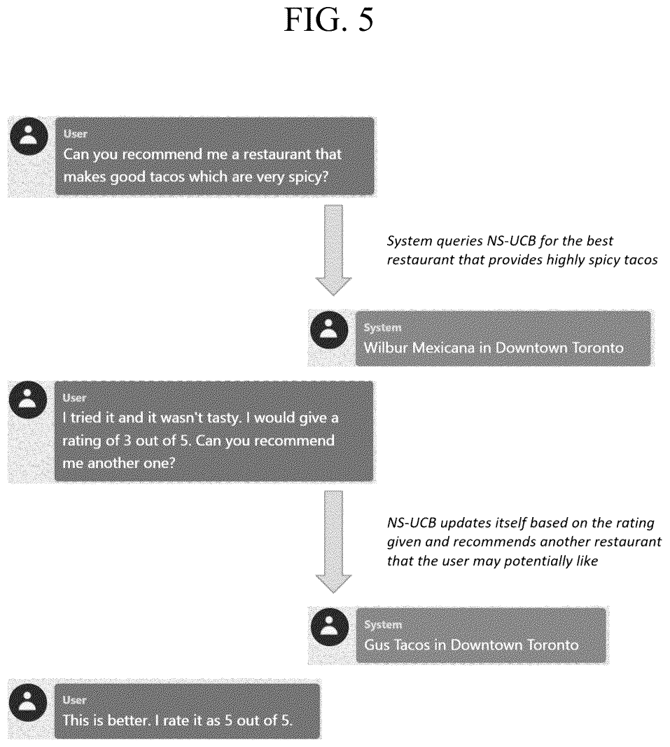

FIG. 4 illustrates a flow chart showing an example method of a recommender device, according to an embodiment of the present disclosure. The recommender device (e.g., an AI device) can be configured as a non-stationarity, upper confidence bound (NS-UCB) multi-armed bandit recommender. The AI device 100 in FIG. 1 can implement the method shown in FIG. 4.

As shown in FIG. 4, according to an embodiment, the method can include obtaining item information for a group of items and user preference information (e.g., S400). The item information can include item identification information, attribute information for each item, summary information, an image or thumbnail for each item, price information, etc. Also, the user preference information can include user ratings for items, user engagement time information associated items, click-through event information, viewing information, whitelist information, and blacklist information etc.

Further, the method can further include recommending each item within the group of items at least one time to output a first plurality of recommendations and receiving rewards for the first plurality of recommendations (e.g., S402). The recommendations can be displayed on a display screen of the recommender device (e.g., AI device 100) and/or output with audio information via a speaker in the recommender device.

The method can further include storing a weighted average reward for each item within the group of items in a memory of the recommender device, and storing a number of times each item within the group has been recommended in the memory (e.g., S404). Also, steps 402 and 404 can be repeated for K number of times, in which K can be set equal the number of items in the group, but embodiments are not limited thereto. For example, K can be set to a larger number than the number of items in the group, such as a multiple of the number of items in the group (e.g., 2× or 4× the number of items, etc.), but embodiments are not limited thereto.

According to another embodiment, K can be set to a predetermined time period. For example, K can be set equal a training time period, e.g., K can be set equal to one week, one month, one year, etc. In this situation, steps 402 and 404 can be repeated until a predetermined amount of time has elapsed or a predetermined number of recommendations has been reached. Also, according to an embodiment, the value K can be manually set or adjusted by the user.

Also, steps 402 and 404 can be referred to as an exploration stage during which information is gathered.

Further in this example, the method can include determining a maximum expected reward value for each item within the group of items based on the weighted average reward received for each item within the group of items, an upper confidence bound value for each item within the group of items and a user preference value for each item within the group of items (e.g., S406), and outputting a recommendation identifying an item having a highest maximum expected reward among the group of items (e.g., S408). Steps S406 and S408 can be repeated until T number of recommendations has been made. Also, T can be set equal to a predetermined time period and once the predetermined time period expires the method can be reset to enter steps 402 and 404 again, or T can be set to run indefinitely.

In step S408, the recommendations can be displayed on a display screen of the recommender device (e.g., AI device 100) and/or output with audio information via a speaker in the recommender device. Also, steps S406 and S408 can be referred to as an exploration-exploitation stage.

Algorithm 1 presented below, shows example pseudo code for a recommender device (e.g., AI device 100) that implements a non-stationarity, upper confidence bound (NS-UCB) multi-armed bandit method that takes into account user preferences, according to an embodiment of the present disclosure.

Algorithm 1: NS-UCB

```
  Input: K, T, α, γ
1  for 1 ≤ t ≤ K do
2 | Recommend item t and receive reward rₜ
3 | nₜ^{t} ← γ^{K-t}
4 | \hat{μ}ₜ^{t} ← rₜ
5 for K < t ≤ T do
    |
6 |  $Recommend item {a}_{t} ← arg {max}_{a ∈ 𝒜} {\hat{μ}}_{t - 1}^{a} + α \sqrt{\frac{log ( e + log t )}{{\hat{μ}}_{t - 1}^{a}}} + {β}_{t}^{a} and receive reward {r}_{t}$
    |
7 | ∀a ∈ [symbol]   : nₜ^{a} ← γnₜ₋₁^{a}
8 | nₜ^{a}^{ₜ} ← nₜ₋₁^{a}^{ₜ} + 1
9 |  ${\hat{μ}}_{t}^{{a}_{t}} ← {\hat{μ}}_{t - 1}^{{a}_{t}} + \frac{{r}_{t} - {\hat{μ}}_{t - 1}^{{a}_{t}}}{{n}_{t}^{{a}_{t}}}$
```

In Algorithm 1 above, K corresponds to the number of items, T corresponds to the total number of recommendations to be made, A corresponds to the set of K items, where K and T are positive integers, e is Euler's number, and t corresponds to the item recommendation round. Also, each of the items to recommend within the set can correspond to the multiple arms of a multi-arm bandit (e.g., presenting a recommended item to a user can be viewed similar to an arm pull of a slot machine).

According to an embodiment, a recommender device (e.g., AI device 100) can include an exploration stage, followed by an exploration-exploitation stage. Lines 1-4 in Algorithm 1 can correspond to the exploration stage and lines 5-9 can correspond to the exploration-exploitation stage.

According to an embodiment, a recommender can include an exploration stage where: i) each item in the group is recommended at least once to gather feedback referred to as a reward, ii) the weighted average reward for each item is recorded, and iii) the number of times each item has been recommended is tracked and stored in memory. Further, the recommender can include an exploration-exploitation stage, subsequent to the exploration state, where: iv) a weighted average reward value, an upper confidence bound value, and a user preference value are calculated for each item based on the gathered data, and v) the item having the highest sum of the maximum expected reward, the upper confidence bound value, and the user preference value is the item that is selected and recommended to the user.

For example, the first term in the recommendation function at line 6 in Algorithm 1 can correspond to the “exploitation” part of the exploit and explore stage, the second term can correspond to the “exploration” part of the exploitation and exploration stage, and the third term can take into account user preferences (e.g., “soft” preferences and “hard” preferences) and provide an additional “boost” for items that a user has a preference for, as further detailed below.

Further, instead of assuming the reward distribution for each item remains unchanged, the non-stationarity of the recommender assumes that the reward distribution for each item can change from time to time. Thus, instead of having fixed expected rewards, there are time dependent expected rewards.

The first term in the recommendation function at line 6 in Algorithm 1 above, e.g., \hat{μ}ₜ₋₁^{α}, corresponds to the weighted average reward for each item up until the current time point or the current recommendation round (e.g., 1). The first term can be used to bias recommendation selection towards selecting or recommending the item that has the highest weighted average reward among the set, up until that point in time. This aspect can be described as calculating a maximum expected reward value for each item within the group of items based on the average reward received for each item. The second term and the third term in line 6 balance the first term, as described in more detail below.

The second term in the recommendation function at line 6 in Algorithm 1 above, e.g.,

$$α \sqrt{\frac{log ( e + log t )}{\text{?}}} ,$$

$$\text{?} \text{indicates text missing or illegible when filed}$$

corresponds to an upper confidence bound (UCB) value for each item within the group of items and is an iterative logarithm. In order to compute a high probability maximum limit bound of the expected reward mean, this value is added to the weighted average reward mean. Also, this second term represents the “explorative part” of the exploitation and exploration stage. For instance, items among the set that have been recommended a fewer number of times will have their corresponding weighted sum n set to a smaller number, and as the corresponding weighted sum n of a given item becomes smaller, the contribution of the second term for that given item will become larger. In other words, this portion of the function allows Algorithm 1 to explore or recommend items that have not been recommended in a long time.

The third term in the recommendation function at line 6 in Algorithm 1 above, e.g., βₜ^{α}∈[−1,0] can represent a user preference score assigned to a given item a. Items with higher user preference scores (e.g., greater than −1) can be prioritized or weighted heavier, in which this can be referred to as a user “soft preference.” Conversely, items with lower user preference scores (e.g., −1 or lower) can be excluded from consideration altogether, in which this can be referred to as a user “hard preference.” Also, user preference values for items can be updated over time.

For example, in a situation in which the recommender is used for recommending movies, a user can set a “soft preference” indicating that the user enjoys watching comedies and the user can set a “hard preference” indicating that the user hates horror movies, then the recommender can give comedies an additional boost for the chances of being recommended to the user while horror movies can be excluded from being recommended. For example, this additional recommendation boost corresponds to the third term in the recommendation function at line 6 in Algorithm 1 above, e.g., βₜ^{α}∈[−1,0].

Further, hyperparameter α can be set to 1, and hyperparameter γ can be set to 0.9999, but embodiments are not limited thereto. For example, hyperparameter γ can be set to a smaller number, such as 0.999, or 0.99, etc.

Also, according to embodiments, hyperparameter γ can be adjusted in order to tune how “forgetful” Algorithm 1 is, e.g., as hyperparameter γ approaches 1, nearly all of the previously received rewards for recommended items will continue to be factored into consideration when determining a recommendation (e.g., low forgetfulness), and as hyperparameter γ is set to a lower number, only the rewards corresponding to more recently recommended items will be considered when making recommendations (e.g., high forgetfulness). For example, if γ is set to 1, then all past rewards are considered, and if γ is less than 1, then very old reward values will be ignored or forgotten.

In other words, γ can help account for non-stationarity (NS) that is present in user rewards. For example, if a user's tastes change quickly (e.g., as young peoples' tastes often do change rapidly), then γ can be set to a lower value. However, an older person's tastes may be more solidified in old age and he or she may be more reluctant to try new things, in which γ can be set to a higher value.

According to an embodiment, γ can be set on a per user basis based on one or more of a user's age, gender, ethnicity, religion, national origin, geographic location, time of day, season, etc., but embodiments are not limited thereto. For example, according to an embodiment, γ can be set by the user (e.g., the user can adjust a setting to tune how often new or different types of items are recommended). In other words, the user can determine or manually adjust how adventurous or conservative they want their personalized recommendations to be.

In addition, the rewards r, can be in [0,1]. According to an embodiment, the recommender device (e.g., AI device 100) can normalize ratings received from users to be either 0 or 1. For example, users can be requested to assign a rating from 0-5 stars for a recommended item, in which a rating of 3 or more stars can be normalized to 1, and a rating of less than 3 stars can be normalized to 0, but embodiments are not limited thereto.

FIG. 5 illustrates an example of a user interacting with an AI device according to an embodiment of the present disclosure. According to an embodiment the AI device 100 in FIG. 1 can implement an interactive chat bot to provide recommendations, as shown in FIG. 5.

For example, a user can present a question to the AI device 100, such as “Can you recommend me a restaurant that makes good tacos which are very spicy?” in which the AI device and use the NS-UCB algorithm discuss above to recommend the best restaurant among a group of taco restaurants that provides highly spicy tacos. The AI device 100 can display a recommended item to the user, e.g., by outputting “Wilbur Mexicana in Downtown Toronto.”

Further in this example, the user can provide the AI device 100 with a rating or a reward for the recommended item, e.g., the user rating can include the user inputting “I tried it and it wasn't tasty. I would give is a rating of 3 out of 5. Can you recommend another one?” The AI device can use the user rating to update the user preferences.

Upon receiving the subsequent request for another recommendation from the user, e.g., “ . . . Can you recommend another one?,” the AI device 100 can update itself based on the previous reward and user preference information, and recommend another restaurant that the user may potentially enjoy. In this situation, the NS-UCB algorithm can treat the group of restaurants available to be recommended to the user similar to the number of slot machines, a recommended restaurant can be treated similar to an arm pull of a given slot machine, and the user rating received can be treated similar to the reward output from the slot machine.

However, the AI device 100 is not limited to recommending restaurants. For example, the AI device 100 implementing the NS-UCB algorithm can be used to recommend various types of items, such as movies, products, clothes, videos, webpages, routes, etc. According to an embodiment, the AI device can be configured to recommend home appliance devices, mobile electronic devices or display devices to a user. The AI device 100 can be used in various types of different situations.

Regarding self-driving vehicles or robots, the recommender device can be used to suggest a specific route, path or commute to a user from among a plurality of routes, and provide more tailored recommendations during later sessions.

According to one or more embodiments of the present disclosure, a recommender can solve one or more technological problems in the existing technology, such as providing improved performance for recommendations while better adapting to non-stationarity that is present in feedback or reward signals, and consistently recommend items or actions that align with evolving preferences, while also reducing computation time and conserving resources.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
storing, in a memory of the AI device, item information, user preferences and reward feedback information;
obtaining, via a processor in the AI device, item information for a group of items;
receiving, via the processor, at least one user preference;
during an exploration stage, recommending each item within the group of items at least one time for outputting a first plurality of recommendations and receiving rewards for the first plurality of recommendations, storing a weighted average reward for each item within the group of items in the memory, and storing a number of times each item within the group has been recommended in the memory; and
during an exploration-exploitation stage subsequent to the exploration stage, determining a maximum expected reward value for each item within the group of items based on the weighted average reward received for each item within the group of items, an upper confidence bound value for each item within the group of items and a user preference value for each item within the group of items, and outputting a recommendation identifying an item having a highest maximum expected reward among the group of items.

2. The method of claim 1, wherein the maximum expected reward value for a specific item within the group of items is a sum of the weighted average reward received for the specific item, the upper confidence bound value for the specific item and the user preference value assigned to the specific item.

3. The method of claim 1, wherein a sum of the weighted reward average and the upper confidence bound value represents a highest possible expected mean value of a reward distribution for a corresponding item within the group of items.

4. The method of claim 1, wherein the exploration stage is carried out K times to generate the first plurality of recommendations, K being equal a number of items within the group of items.

5. The method of claim 1, wherein the user preference value is a rating received from a user that is normalized to be a value in a range of −1 to 0.

6. The method of claim 1, further comprising:
updating a weighted sum for each item within the group of items, the weighted sum being based on a number of times a corresponding item has been recommended,
wherein the upper confidence bound value becomes larger as the weighted sum becomes smaller.

7. The method of claim 1, further comprising:
displaying, on a display of the AI device, the recommendation identifying the item having the highest maximum expected reward among the group of items.

8. The method of claim 1, wherein the upper confidence bound value is based on an iterative logarithm function.

9. The method of claim 1, wherein the receiving the at least one user preference includes:
receiving a chat message or a text message from the user including a rating or a score.

10. The method of claim 1, wherein the group of items is a group of movies, a group of advertisements, a group of restaurants, a group of available routes to a destination, or a group of videos.

11. The method of claim 1, wherein the AI device includes at least one of a smart television, a mobile phone, and a robot.

12. An artificial intelligence (AI) device for providing recommendations, the AI device comprising:
a memory configured to store item information, user preferences and reward feedback information; and
a controller configured to:
obtain item information for a group of items,
receive at least one user preference,
during an exploration stage, recommend each item within the group of items at least one time for outputting a first plurality of recommendations and receiving rewards for the first plurality of recommendations, store a reward for each item within the group of items in the memory, and store a number of times each item within the group has been recommended in the memory, and
during an exploration-exploitation stage subsequent to the exploration stage, determine a maximum expected reward value for each item within the group of items based on a weighted average reward received for each item within the group of items, an upper confidence bound value for each item within the group of items and a user preference value for each item within the group of items, and output a recommendation identifying an item having a highest maximum expected reward among the group of items.

13. The AI device of claim 12, wherein the controller is further configured to:
determine the maximum expected reward value for a specific item within the group of items by taking a sum of the weighted average reward for the specific item, the upper confidence bound value for the specific item and the user preference value assigned to the specific item.

14. The AI device of claim 12, wherein a sum of the weighted reward average and the upper confidence bound value represents a highest possible expected mean value of a reward distribution for a corresponding item within the group of items.

15. The AI device of claim 12, wherein the controller is further configured to:
carry out the exploration stage K times to generate the first plurality of recommendations, K being equal a number of items within the group of items.

16. The AI device of claim 12, wherein the user preference value is a rating received from a user that is normalized to be a value in a range of −1 to 0.

17. The AI device of claim 12, wherein the controller is further configured to:
update a weighted sum for each item within the group of items, the weighted sum being based on a number of times a corresponding item has been recommended,
wherein the upper confidence bound value becomes larger as the weighted sum becomes smaller.

18. The AI device of claim 12, wherein the upper confidence bound value is based on an iterative logarithm function.

19. A method for controlling an artificial intelligence (AI) device, the method comprising:
storing, in a memory of the AI device, item information, user preferences and reward feedback information;
obtaining, via a processor in the AI device, item information for a group of items;
receiving, via the processor, at least one user preference;
in response to receiving a first recommendation request, recommending a first item within the group of items for outputting a first recommendation;
receiving a first reward for first recommendation;
storing an average reward for the first item in the memory, the average reward being based on the first reward;
storing a number of times the first item has been recommended in the memory; and
in response to receiving a second recommendation request, determining a maximum expected reward value for the first item based on a sum of the weighted average reward, an upper confidence bound value for the first item and a user preference value for the first item, and outputting a second recommendation based on a highest maximum expected reward for the first item.

20. The method of claim 19, wherein the determining the maximum expected reward value for the first item includes:
taking a sum of the weighted average reward for the first item, the upper confidence bound value for the first item and the user preference value for the first item.
